(19) United States
(12) Patent Application Publication
(10) Pub. No.: US 2019/0159289 A1
(43) Pub. Date: May 23, 2019

(54) AN INSTANTANEOUS HEATING DEVICE FOR SOLID, LIQUID, GAS AND VAPORS

(71) Applicant: REDOX S.R.L., REGGIO EMILIA (RE) (IT)

(72) Inventors: ANGELO BONI, REGGIO EMILIA (IT); MARCO MAZZALI, RIO SALICETO (IT)

(21) Appl. No.: 16/091,605

(22) PCT Filed: Apr. 10, 2017
(86) PCT No.: PCT/IB2017/052058

§ 371 Date: Oct. 5, 2018

(30) Foreign Application Priority Data
Apr. 12, 2016 (IT) 102016000037556

(51) Int. Cl. H05B 1/02; H05B 3/00

(52) U.S. Cl. CPC H05B 1/0297; G05D 23/2401; H05B 3/0019

(57) ABSTRACT

A heating device, comprising: a heater (2) made of a material the electrical resistance of which is variable according to a temperature; a power source (1, 10) connected to the heater (2) by means of electrical connections (8, 9) for sending an electric current which flows through the heater (2); a control module (4) that is arranged for adjusting the current supplied by the power source (1); measuring connections (6, 7) placed at the ends of the heater (2) and connected to the control module (4), which control module (4) is predisposed for measuring the resistance of the heater (2) by calculating a ratio between the voltage present at the ends of the heater (2) and the current crossing the heater (2), which are detected by way of the measuring connections (6, 7).

The present invention relates to an instantaneous heating device for solids, liquids, gases and vapors.

The energy saving in every machine, household appliance, transport system or dwelling, is of the greatest importance as it reduces the working costs and the pollution produced by energy sources. In particular in all applications where heating an element, whether liquid, solid, gas or vapor, is actuated discontinuously, there is a great waste of energy since before heating the element it is necessary to bring the heating system to temperature. Said heating system generally has a thermal mass that is substantially greater than the thermal mass of the element to be heated. In many cases the heating time is too long and it is necessary to continuously maintain the heating element at temperature, even though the element to be heated is not present for very long times.

The significant thermal mass of the heater is necessary for maintaining the temperature constant upon a variance in the expected working conditions; the heater is in fact usually provided with a temperature sensor and a control system of the heating power. During the heating step the power applied is at a maximum, then, on reaching the working temperature the heater maintains the required temperature by switching the heating element on and off with a useful cycle for example of 10%; when the element to be heated enters into contact with the heater, thermal energy is absorbed, passing from the heater to the element to be heated. The heater therefore tends to cool and the temperature control system sends more power to the heating system. In this regime a temperature transient occurs, with even considerable leaps between what is detected by the control system and how much is transferred to the element to be heated. These transients are in general absorbed by the relevant thermal mass of the heater (a practical rule is that with a thermal mass of 20 times greater than the thermal mass of the element to be heated, the transient is contained within a few percentage points of the requested heating temperature).

By way of non-limiting example, we mention the sealing systems of cardboard and/or plastic trays for foods, used in supermarkets to close packs of perishable foods.

Said machines are made up of a lower base, comprising adjustable tray holders and an upper heating plate, with a typical power of 1 KW and a metal mass (typically aluminium) of at least 1 Kg. The element to be heated is the border of said trays for foods, which will be sealed with a film of plastic material; the weight of the part to be heated is about 5 grams. The sealing temperature is typically 180° C. so the energy for heating the plate will be: 880 J (specific heat of aluminium)×1 Kg (weight of the heater)×180° C.−25° C.=155° C. (sealing temperature−ambient temperature) from which: 880×1×155=136,400 Joule, while the heating time of the plate will be: 136.4000 J/1000 W of heating power=136.4 seconds.

To seal the tray the following will instead be necessary:

1200 J (mean specific heat cardboard+plastic)×0.005 Kg (weight of the part to be heated)×155° C. (sealing temperature−ambient temperature)

from which:

1200×0.005×155=930 J

Calculating the percentage ratio between the energy used for sealing the tray and the total energy used for heating the plate plus the tray, we obtain: 930/(136,400+930)×100=0.68%, i.e. less than 1% of the energy used for heating the machine serves to seal the tray.

In the case of a machine that is always switched on, while waiting for work to carry out, and hypothesising that the energy dispersed in the environment will be equal to 1/10 of the maximum power, we obtain:

100 W×12 hours of functioning=1200 W/h, which we will multiply by 3600 to transform it into Joules, from which 1200×3600=4,320,000 J, to which we have to add the Joules for the initial heating: 4,320,000+136,400=4,456,400 J. If we hypothesis sealing one tray per minute (typical rhythm of a supermarket counter) we will have 4,456,400 J+(930 J×720)/720 (1 piece per minute for 12 hours)=7119 J, and, as a percentage: 930×7119×100=13%. In this case too, though better than before, the unused energy is the main component in the total (87%).

The aim of the present invention is to provide a heating device that enables obviating the drawbacks of the currently available heaters, enabling a significant energy saving.

Further characteristics and advantages of the present invention will become more apparent in the following detailed description of an embodiment of the present invention, illustrated by way of non-limiting example in the attached figures, in which:

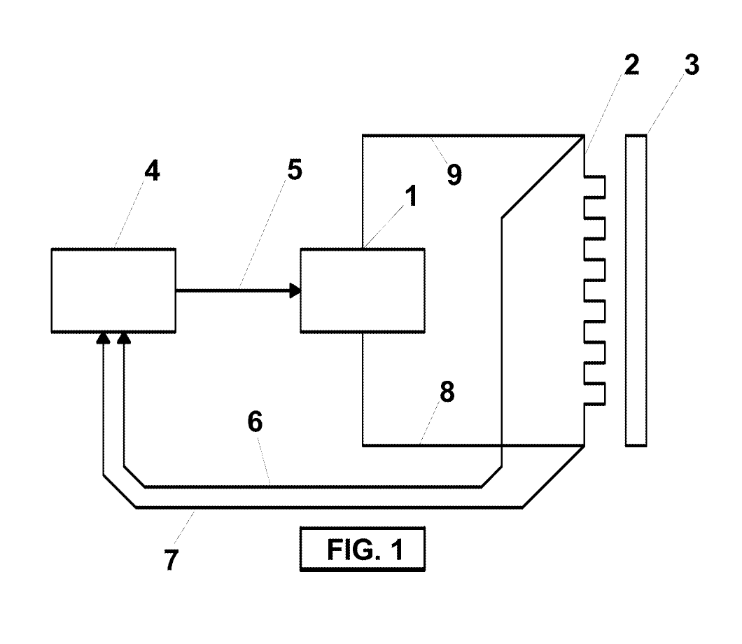

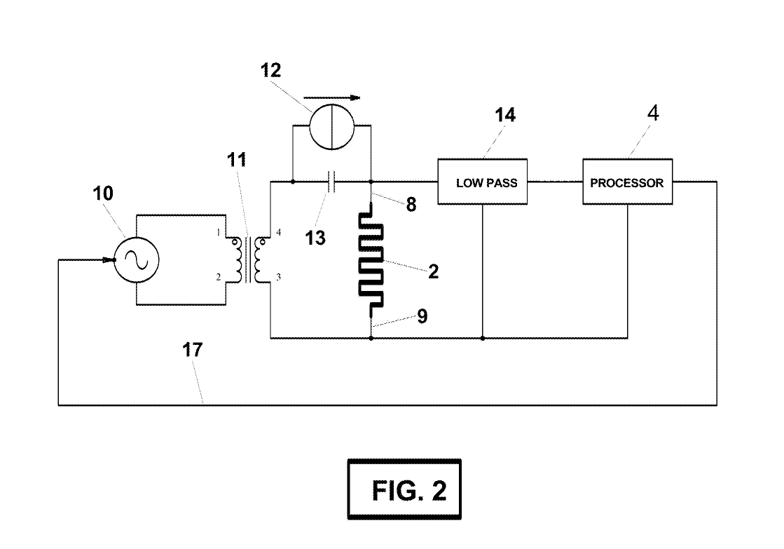

FIG. 1 is a schematic illustration of a first embodiment of the heating device according to the present invention;

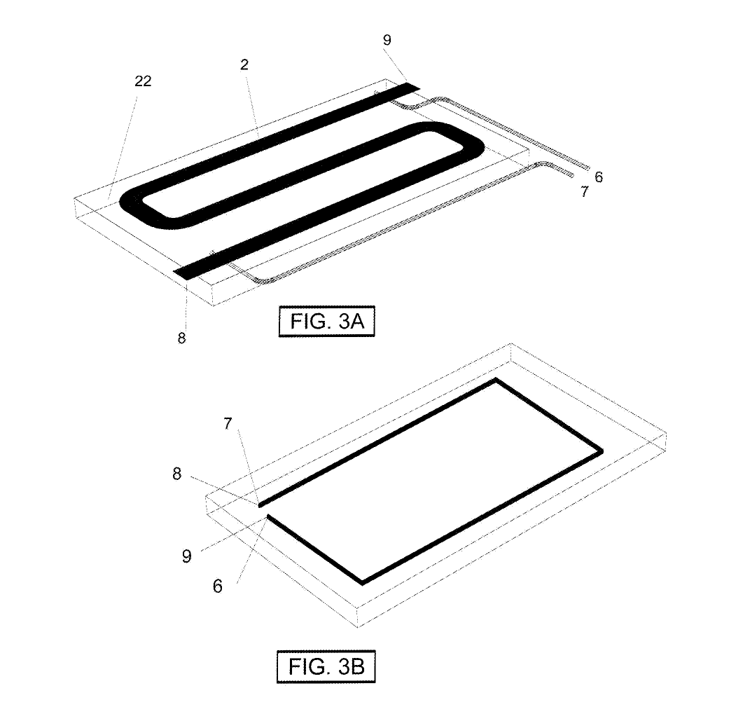

FIG. 2 is a schematic illustration of a second embodiment of the heating device according to the present invention;

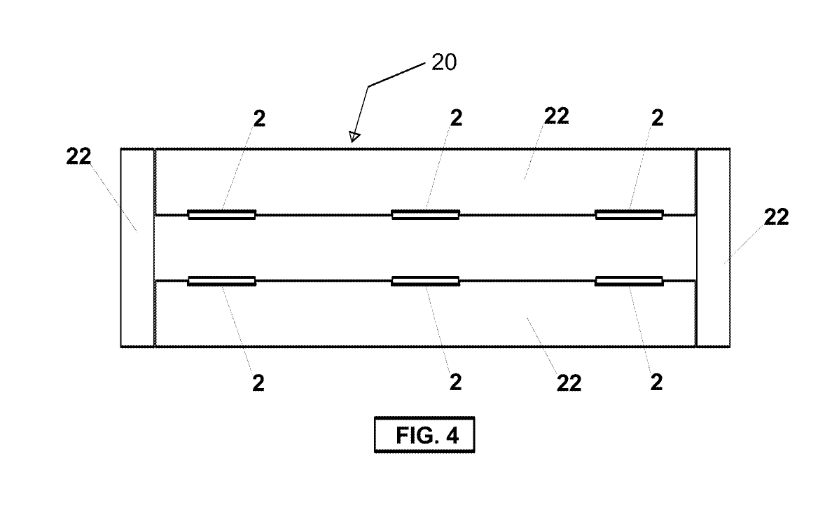

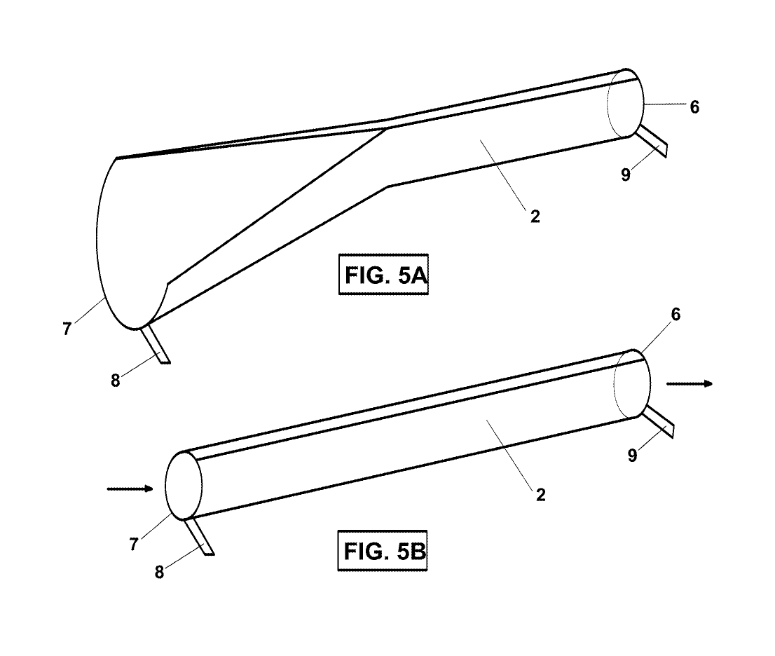

FIGS. 3A, 3B, 4 and 5 illustrate further constructional variants of a heating device according to the present invention;

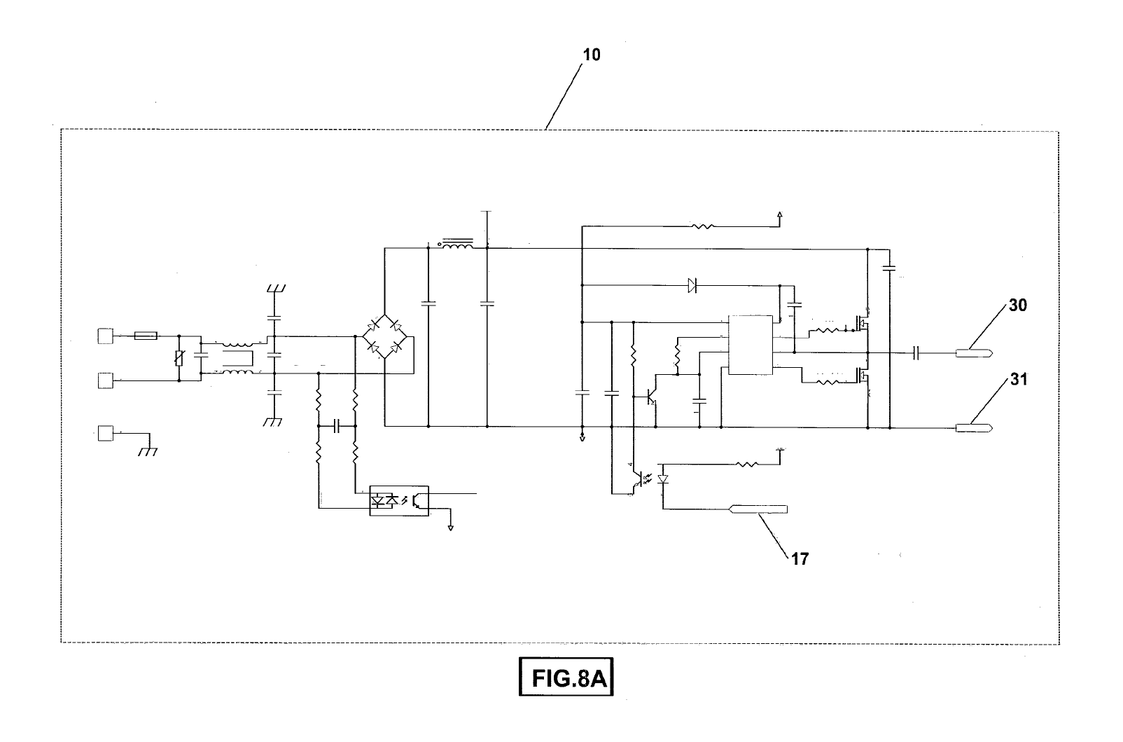

FIG. 6 is a time/temperature qualitative graph for the heating of the device according to the present invention;

FIG. 7 illustrates an embodiment of the device, which includes recovering a working heat;

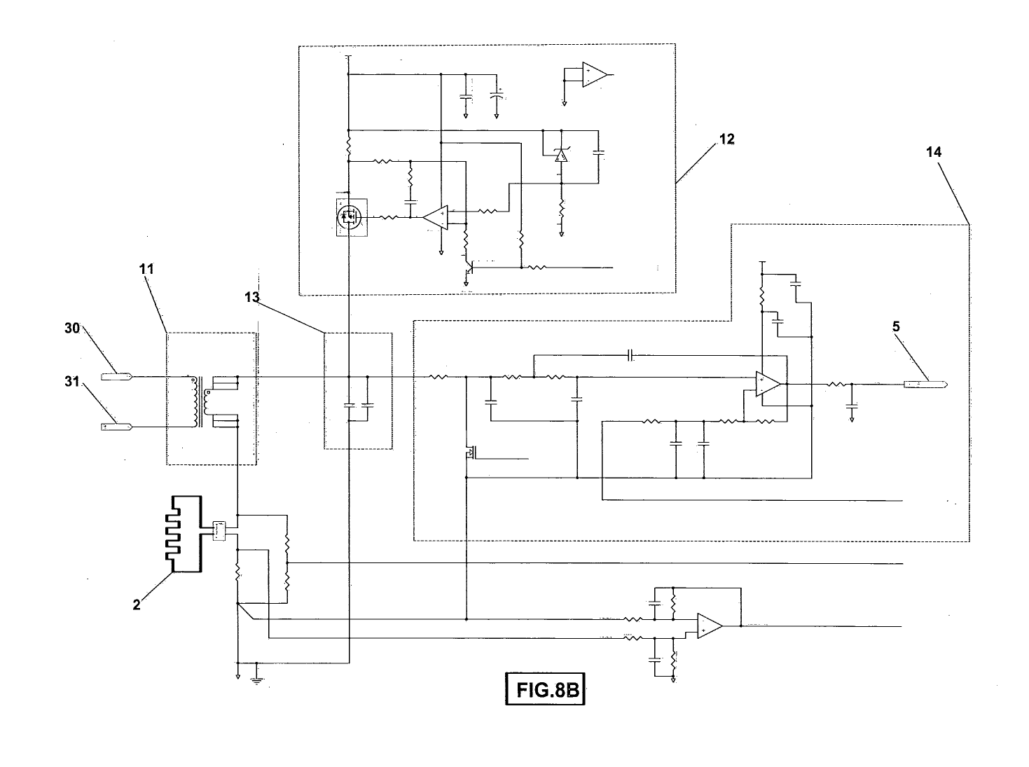

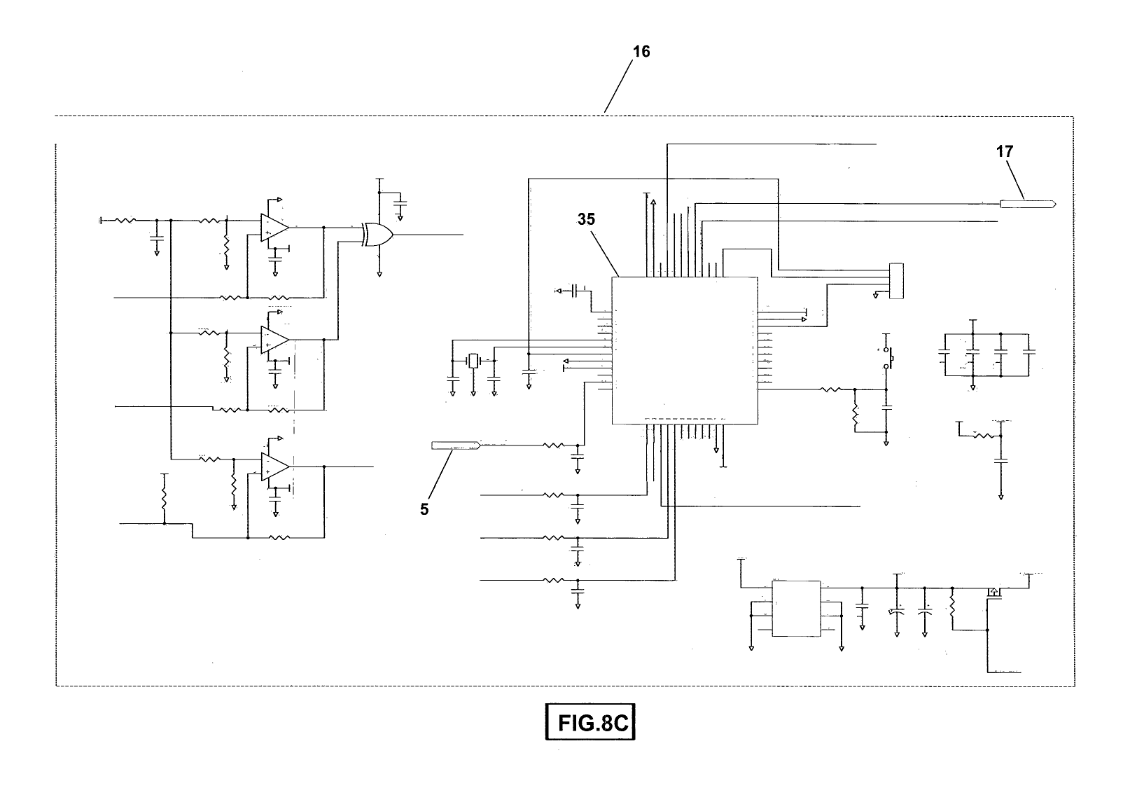

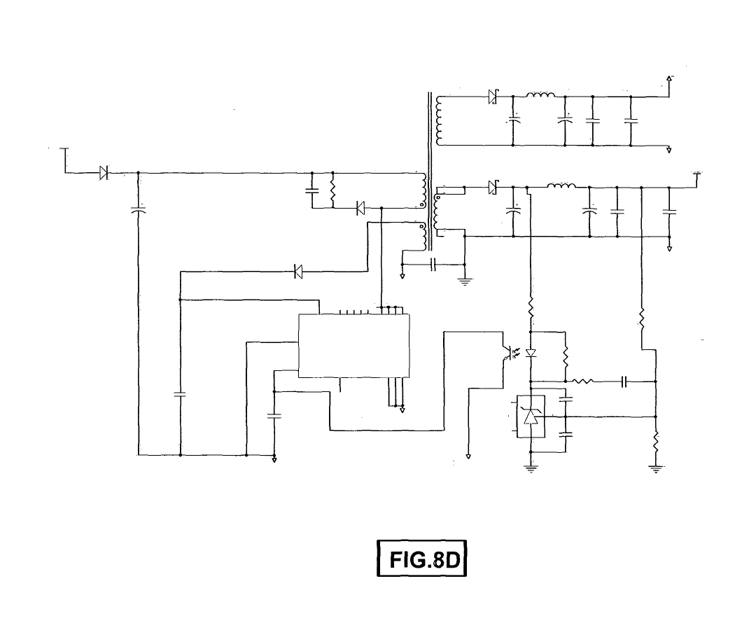

FIGS. 8A, 8B, 8C, 8D are conventional diagrams of the heating device according to the present invention, in an illustrated embodiment powered by a 230V electric grid with 2 KW power and a heater operating at low voltage at about 40 Volt.

As illustrated in FIG. 1, the heating device according to the present invention comprises a power source 1, which in the present example can be a battery or a rectifier which provides a direct current in output.

The heating device further comprises a heater 2, which can be conformed so as to maintain the thermal mass very low. The heater 2 is made of a metal material an electrical resistance of which is variable according to a temperature, for example copper, brass, bronze, steel, aluminium. Electrical connections 8, 9 are predisposed for connecting the heater 2 to the power source 1. The heater 2 is therefore crossed by an electric current powered by the power source 1. The heater 2 can be placed in close contact with the element 3 to be heated, so as to effectively transfer the heating power.

A control module 4, by means of measuring connections 6, 7, detects the resistance of the heater 2, by calculating the ratio between the voltage present at the heater ends and the current flowing through the heater 2. The control module 4 utilises the resistance calculated as the reference value for controlling the temperature. By means of a connecting device 5, the control module 4 sends an adjustment signal to the power source 1, which varies the power sent to the heater 2 on the basis of instant-by-instant heating needs. The connecting device 5 is able to vary either the voltage of the power source 1 or to adjust the voltage over time using the PWM method or another known method.

While the traditional systems require a large thermal mass in order to contain the temperature leaps caused by the variation in the working conditions, the present invention utilises the heater 2 itself as the temperature sensor. This enables accurately monitoring the temperature of the heater 2 instant by instant and, since the heater 1 is placed in close thermal contact with the element to be heated 3, even the temperature of this element can be controlled very precisely.

Given the low thermal mass of the heater 1, it is further possible to make the control module 4 work with very frequent control cycles, in the order of thousands per second, while today's typical adjustment technologies operate in the order on one cycle per second. This is because the thermal mass of the heater is so high as to utilise tens of seconds or even minutes in order to reach the temperature, while, in the heating device according the present invention, the heater requires a heating time in the order of 0.1-0.2 seconds, which enables the control module to operate even at a rate of thousands of times per second.

FIG. 2 illustrates a second embodiment of the heating device, in which the power source 10 is at high frequency, for example a semiconductor inverter.

An inverter can work at ultrasonic frequencies, up to various hundreds of KHz. In these conditions the calculation of the resistance of the heater 2, performed as a ratio between the vector values of voltage and current, is rather complex. To avoid said complexity, the heating device comprises a current source 12, predisposed to supply a known current.

In particular, a capacitor 13 and the direct current source 12 are connected to the transformer output 11, connected to the primary of the power source 10. A low-pass filter 14 is also connected in parallel to the heater 2 and provides in output an adjustment signal, sent to the control module 4, in turn connected to the source 10, by a connection 17.

The heating device illustrated in FIG. 2 functions in the following way.

The power of the source 10 is transmitted to the heater 2 via the transformer 11 and the capacitor 13. The capacitor 13 is dimensioned so as to have a minimum resistance to passage of the alternating current by which it is crossed. The current source 12, connected in parallel to the capacitor 13, sends a known direct current to the heater 2, which is therefore crossed by the alternating current coming from the source 10 and by the known direct current coming from the source 12. There is therefore a voltage present at the ends 8, 9 of the heater 2, given by the product of the current crossing the heater 2 by the resistance thereof. The low-pass filter 14 removes the alternating component of the voltage and leaves only the direct current voltage generated by the known current coming from the source 12. As the resistance of the heater 2 is a function of the temperature, even the voltage extracted by the low-pass filter 14, will be a function of the temperature.

The power source 10 can also be constituted by the electric grid at 110-230V at 50 or 60 Hz. In this case the transformer and the other circuits will be dimensioned for said working frequency.

FIG. 3A represents a planar embodiment of the heater 2. In particular, the heater 2 is deposited on a flat surface 22 of thermally and electrically insulating material. The electrical connections 8, 9 are predisposed to be connected to the power source 1, 10, while the measuring connections 6, 7 are predisposed for being connected to the control module 4. This configuration of the heater 2 is especially suitable for heating solid elements. For example, as illustrated in FIG. 3B, the heater 2 can be conformed for matching the shape of a tray to be sealed.

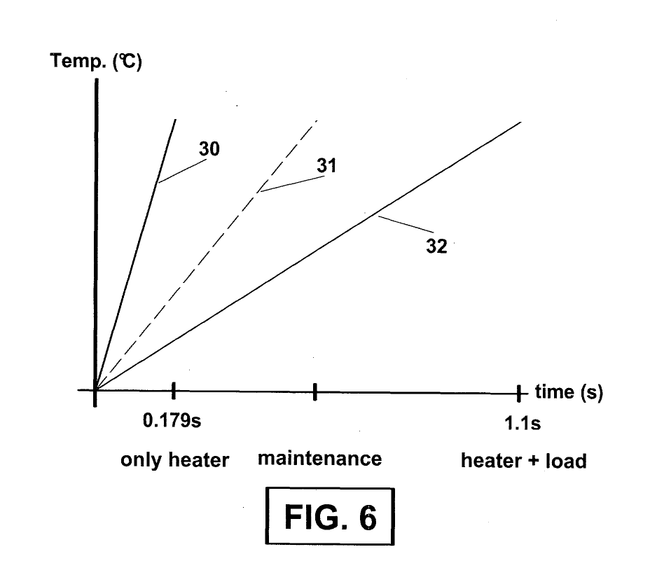

FIG. 4 illustrates an embodiment of a heater unit 20 in which two or more heaters 2 are coupled to form a containing system of an object to be heated. The heaters 2 can be electrically connected in series or in parallel according to the power supply needs with a higher voltage in a case of elements in series and a lower voltage in a case of elements connected in parallel. The heater unit 20 is particularly suitable for heating liquids, vapors and gases.

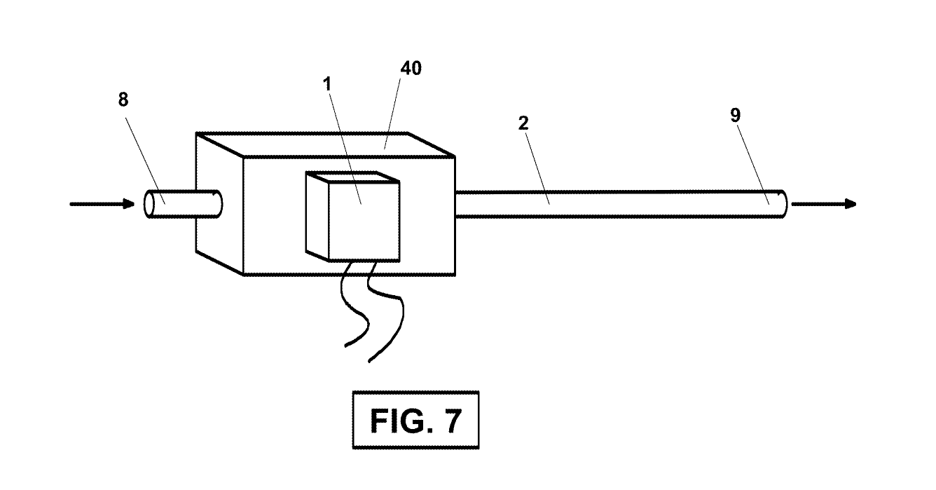

FIG. 5 illustrates a heater 2 bent to form a tube able to convey liquids, gases and vapors. The measuring connections 6, 7 and the electrical connections 8, 9 are predisposed for the same connections as already described for the preceding embodiments.

The perfect thermal contact between the heater 2 and the element to be heated enables considerably increasing the efficiency of the heating device according to the present invention.

However, in the case of use for heat-welding of trays or fusion of other materials, undesired encrustations might be accumulated on the heater 2, for example glues, or lime scale or solid oil residues and so on. It is very important to be able to detect the presence of any accumulation or encrustation, before it becomes such as to make the system malfunction. By way of example, it is possible to establish a tolerable maximum drop in the heat transmission between the heater 2 and the object to be heated, for example a drop of 20%.

Thanks to the rapidity of the control module and the possibility of measuring the resistance of the heater, an indication of the state of cleanliness of the heater can be obtained. FIG. 6 shows a qualitative graph of the heating time as a function of the temperature for the heater illustrated in FIG. 1, utilisable for sealing the trays for foods.

The time required for heating the clean heater 2 in air is about 0.18 seconds (curve “30”), while the time for the heating of the clean heater 2 in contact with the tray is 1.1 seconds (curve “32”), calculable as the total heat necessary divided by the power delivered by the source 1, 10, i.e.:

179+960 Joule/1000 W=1.1 seconds.

When the heater 2 is dirty or encrusted, and the thermal contact with the tray is no longer perfect, the time it takes the heater to reach the temperature will be shorter (curve “31”) with respect to the case in which the heater 2 is clean. By measuring the time required for reaching the desired temperature, it is therefore possible to obtain an index of the degree of cleanliness/encrustation of the heater. All of the above is also valid in regard to a case in which the heater 2 is predisposed for containing liquids, vapors or gases.

By taking account of the index of cleanliness/encrustation obtained, it is possible to compensate for the low thermal transfer of the heater to the element to be heated, by increasing the contact time between the heater 2 and the heating element 3, or by reducing the transit velocity of the fluid to be heated in the embodiment of FIGS. 5A and 5B, or yet by increasing the working temperature of the heater 2.

In a case in which a fluid is heated, it is possible to calculate the quantity of material heated (flow rate) on the basis of the heat used in the heating. For example, if 1000 Joule are required for heating a gram of a certain material from ambient temperature to a desired temperature, by calculating the Joules effectively used, for example 10,000 Joule, it is possible to know the weight or volume of the heated material, in this example 10 grams.

The working heat produced by the components utilised, and in particular the heat produced by the components of an electrical/electronic nature, can be used for heating a cooler zone of the heater 2. FIG. 7 illustrates an example in which the heater 2, in the tubular shape, takes heat from a heat sink 40 of the electronic power parts of the source 1, which heat would otherwise be dispersed. The heat sink 40 does not substantially increase the thermal mass of the heater 2, as it is located at a cooler zone of the heater (2), for example the input section of the fluid to be heated.

The heater of the present invention enables obtaining notable advantages in comparison with heaters currently available on the market.

The heater according to the present invention in fact enables reducing the mass of the heating element to only three grams of copper or another metal suitable for passage of the electric current.

In this case the energy required for bringing the heating element to the correct temperature is given by: 385 J (specific heat of copper)×0.003 Kg (weight of the heater)×155° C. (sealing temperature−ambient temperature)=179 Joule. Considering the energy required for sealing the tray, mentioned in the foregoing, we will have the following percentage:

930 J/(179 J+930 J)×100=83.8%

The heating time will not be 136 seconds as before, but 179 J/1000 W=0.179 sec.

The practically instantaneous heating thus enables keeping the heater switched off during the down times or when the heater is not in use, and to switch the heater on only at the moment of use. The energy saving is therefore effective in any working condition both for a single sealing operation and for continuous use. In this second case the efficiency passes from the 15% of the prior art to 83.8%, with the use of the invention.

The illustrated embodiment is alike the construction type of FIG. 2 and is illustrated in detail in FIGS. 8A, 8B, 8C and 8D. In particular, in FIG. 8A the power source 10 is described, constructed with a mosfet inverter, piloted by an IRS2153D driver and controlled by the photo-coupler connected to the control connection 17. Noise filters and filter capacitors are inserted on the power input coming from the single-phase 230 Volt network to eliminate the electrical noise produced by the inverter. The power is sent to the transformer 11, shown in FIG. 8B, via the two connections 30 and 31, to the output of the inverter, composed of the two IPP65R045C7 mosfets. The other functional blocks, like the known current source 12 and the low pass filter 14, perform the functions already described previously. In this example the capacitor 13 is composed of a plurality of elements in parallel. The output 5 of the low pass filter 14 leads to the controller 35 of block 16 of FIG. 8C. The other control circuits present carry out auxiliary functions of protection and are not essential to the description of the invention. FIG. 8D illustrates the auxiliary power source, able to provide the various voltages required for the correct functioning of the heating system.

1) A heating device, comprising: a heater (2) made of a material an electrical resistance of which is variable according to a temperature; a power source (1,10) connected to the heater (2) by means of electrical connections (8,9) for sending an electric current which flows through the heater (2); a control module (4) predisposed for adjusting the current supplied by the power source (1); characterised in that it comprises: measuring connections (6,7) located at the ends of the heater (2) and connected to the control module (4), which control module (4) is predisposed for measuring the resistance of the heater (2) by calculating a ratio between the voltage present at the ends of the heater (2) and the current flowing through the heater (2), which are detected by means of the measuring connections (6,7).

2) The heating device according to claim 1, wherein the control module (4) adjusts the power supplied by the power source (1) on the basis of the resistance measured for the heater (2).

3) The heating device according to claim 2, comprising: a connecting device (5), which is interposed between the control module (4) and the power source (1) and which is suitable for varying a voltage of the power source (1) or for adjusting the voltage over time, by means of a PWM method or an equivalent method.

4) The heating device according to claim 1, wherein the power source (1) is suitable for supplying a direct current.

5) The heating device according to claim 1, wherein the power source (10) is an alternating current.

6) The heating device according to claim 5, comprising: a direct current source (12), which is predisposed for supplying a predetermined current; a capacitor (13), connected in parallel to the direct current source (12); the capacitor (13) and the direct current source are interposed between the power source (10) and the heater (2); a low-pass filter (14), located in parallel to the heater (2) and connected to the control module (4).

7) The heating device according to claim 6, wherein the control module (4) is predisposed for measuring the temperature of the heater (2) by detecting the direct current voltage at the output of the low-pass filter (14).

8) The heating device according to claim 1, wherein the heater (2) is deposited in a predetermined configuration on a flat surface (22) of a thermally and electrically insulating material.

9) The heating device according to claim 1, comprising a heater unit (20) which comprises two or more heaters (2) that are connected together in series or in parallel.

10) A heating device according to claim 1, wherein the heater (2) has a tubular conformation.

11) The heating device according to claim 1, wherein the control module (4) is predisposed for: detecting a time required for reaching a determined temperature of the heater (2); comparing the detected time with a reference time; in the event that the detected time is shorter than the reference time, the control module (4) increases the power supplied by the power source (1,10) and/or increases the contact time between the heater (2) and the object to be heated.

12) The heating device according to claim 1, wherein the control module (4) has, stored in a memory thereof, a specific heat of one or more materials or substances to be heated and is predisposed for calculating a mass of material or substance heated by the heater (2) as a ratio between the total heat supplied and the specific heat of the material or substance.

13) The heating device according to claim 10, wherein the heater (2) is placed in contact with a heat sink (40) of the electronic parts of the power source (1), in a low temperature zone or an inlet zone of a fluid to be heated.

14) A heating device, comprising:
a heater (2) made of a material the electrical resistance of which is variable according to a temperature;
a power source (1,10) in alternating current, connected to the heater (2) by means of electrical connections (8,9) for sending an electric current which flows through the heater (2);
a control module (4) predisposed for adjusting the current supplied by the power source (1);
measuring connections (6,7) located at the ends of the heater (2) and connected to the control module (4), which control module (4) is predisposed for measuring the resistance of the heater (2) by calculating a ratio between the voltage present at the heater ends (2) and the current flowing through the heater (2), which are detected by means of the measuring connections (6,7);
characterised in that it comprises:
a direct current source (12), predisposed for supplying a predetermined current;
a capacitor (13), connected in parallel to the direct current source (12); the capacitor (13) and the source of direct current are interposed between the power source (10) and the heater (2);
a low-pass filter (14) located in parallel to the heater (2) and connected to the control module (4).
